(19) United States
(12) Patent Application Publication
(10) Pub. No.: US 2026/0018664 A1
(43) Pub. Date: Jan. 15, 2026

(54) Production Method For Anode-Supported Cell

(71) Applicants: MITSUI MINING & SMELTING CO., LTD., Tokyo (JP); Honda Motor Co., Ltd., Tokyo (JP)

(72) Inventors: Minoru KAHATA, Ageo (JP); Shingo IDE, Ageo (JP); Yuya KOMORI, Ageo (JP); Miki KUREHA, Ageo (JP); Tsutomu HIGUCHI, Ageo (JP); Takayuki YAMADA, Wako (JP); Yukihisa KANAO, Wako (JP)

(21) Appl. No.: 19/266,259

(22) Filed: Jul. 11, 2025

(30) Foreign Application Priority Data
Jul. 12, 2024 (JP) 2024-112824

(51) Int. Cl. H01M 10/0562

(52) U.S. Cl. CPC H01M 10/0562; H01M 2300/0071

(57) ABSTRACT

A production method includes: heating a first stacked body at 1000° C. or more, the first stacked body having: a layer containing an oxide represented by the composition formula: La₂Si₂O₇; a first layer provided on one side of the oxide-containing layer and containing cerium oxide doped with a lanthanum element; and a layer provided on the first layer opposite to the oxide-containing layer and containing nickel oxide, and thereby generating, from the oxide represented by the composition formula, a solid electrolyte that has an apatite structure and is c-axis oriented; placing a second layer containing cerium oxide doped or not doped with an Ln element (a rare earth element other than cerium), on the solid electrolyte-containing layer opposite to the cerium oxide-containing layer, and thereby obtaining a second stacked body; and heating the second stacked body at 1000° C. or more.

### CROSS REFERENCE TO RELATED APPLICATIONS

The present application claims the benefit of priority to Japanese Patent Application No. 2024-112824 filed on Jul. 23, 2024 with the Japanese Patent Office, the entire contents of which are incorporated herein by reference in its entirety.

### BACKGROUND

### Technical Field

The present invention relates to a production method for an anode-supported cell.

### Related Art

In recent years, attention has been paid to fuel cells as a way to address global warming prevention by reducing CO₂ emissions. Out of fuel cells, a solid oxide fuel cell (SOFC) that is made using a ceramic material can operate at a high temperature and has the highest power generation efficiency among fuel cells. A solid electrolyte used as the main component of the SOFC is required to have a high level of oxide ion conductivity.

For the purpose of enhancing the oxide ion conductivity of the solid electrolyte, for example, WO 2012/015061 discloses a production method for generating a new oxide ion-conducting compound on a bonding interface in which a plurality of substances that have different chemical compositions are contacted. The document also states that, according to this method, for example, by contacting a layer composed mainly of La₂O₃ to a layer composed mainly of La₂Si₂O₇, and then heating these layers, a lanthanum silicate whose c-axis is oriented along the thickness direction can be produced on the bonding interface.

US 2021/0036354 A1 discloses a solid electrolyte assembly that includes: a solid electrolyte layer composed of an oxide that contains La, Si, and B; and a layer composed of cerium oxide doped with La and Sm. The document also states that, when producing the solid electrolyte assembly, by stacking the solid electrolyte layer and the layer composed of cerium oxide doped with Sm, and heating these layers at 1400° C., a high level of oxide ion conductivity can be obtained.

The method for producing a solid electrolyte layer through diffusion of elements by heating as disclosed in WO 2012/015061 is known. However, in order to obtain a solid electrolyte that can be driven as a device by using this method, it requires a process of polishing an unreacted layer that does not exhibit oxide ion conductivity and then removing the unreacted layer from the produced solid electrolyte layer. Also, according to the method disclosed in US 2021/0036354 A1, after a sintered body of the solid electrolyte is obtained, it is necessary to produce a cell by heating a cathode-side intermediate layer, an anode-side intermediate layer, a cathode, and an anode under different conditions.

In this connection, in recent years, for the purpose of further increasing the output power of a SOFC, an anode-supported cell in which a thin solid electrolyte film is achieved by an anode material ensuring the mechanical strength is becoming popular. In general, the anode-supported cell can be obtained by co-sintering the thin solid electrolyte film and the anode material.

However, with the inventions disclosed in WO 2012/015061 and US 2021/0036354 A1, it has been difficult to co-sinter a material for the solid electrolyte layer produced through diffusion of elements by heating and an anode material. Furthermore, in a process of producing an anode-supported cell in which intermediate layers and electrodes are formed after only a single layer is synthesized on the solid electrolyte, it has been difficult to make a thin solid electrolyte layer that can withstand the process.

### SUMMARY

The present invention solves the problem described above by providing a production method for producing an anode-supported cell,
the method comprising:
   a step of heating a first stacked body, in which a layer, a first layer and a nickel oxide-containing layer are stacked, at 1000° C. or more,
      wherein the layer contains an oxide represented by a composition formula: La₂Si₂O₇,
      the first layer is provided on a first side of the layer and contains cerium oxide doped with a lanthanum element, and
      the nickel oxide-containing layer is provided on a first side of the first layer opposite to a second side of the first layer that faces the layer and contains nickel oxide,
   and thereby generating, from the oxide represented by the composition formula, a solid electrolyte that has an apatite structure and is c-axis oriented; a step of placing a second layer that contains cerium oxide that is doped or not doped with an Ln element, where Ln represents a rare earth element other than cerium, on a second side of the layer, which contains the solid electrolyte, opposite to the first side of the layer that faces the first layer, and thereby obtaining a second stacked body; and
   a step of heating the second stacked body at 1000° C. or more,
wherein the nickel oxide-containing layer has a thickness of 300 μm or more and 3000 μm or less.

Also, the present invention provides production method for producing an anode-supported cell,
the method comprising:
   a step of heating a first stacked body, in which a layer, a first layer, a nickel oxide-containing layer and an auxiliary support layer are stacked, at 1000° C. or more,
      wherein the layer contains an oxide represented by a composition formula: La₂Si₂O₇,
      the first layer is provided on a first side of the layer and contains cerium oxide doped with a lanthanum element,
      the nickel oxide-containing layer is provided on a first side of the first layer opposite to a second side of the first layer that faces the layer and contains nickel oxide, and
      the auxiliary support layer is provided on a first side of the nickel oxide-containing layer opposite to a second side of the nickel oxide-containing layer that faces the first layer,
   and thereby generating, from the oxide represented by the composition formula, a solid electrolyte that has an apatite structure and is c-axis oriented;
a step of placing a second layer that contains cerium oxide that is doped or not doped with an Ln element, where Ln represents a rare earth element other than cerium, on a second side of the layer, which contains solid electrolyte, opposite to the first side of the layer that faces the first layer, and thereby obtaining a second stacked body; and
a step of heating the second stacked body at 1000° C. or more.

### BRIEF DESCRIPTION OF THE DRAWINGS

FIG. 1 is a schematic cross-sectional view of an anode-supported cell according to one embodiment that is an object to be produced using a production method of the present invention, taken along a thickness direction of the anode-supported cell.

FIG. 2 is a schematic cross-sectional view of an anode-supported cell according to another embodiment that is an object to be produced using a production method of the present invention, taken along the thickness direction of the anode-supported cell.

FIG. 3 is X-ray diffraction charts of solid electrolyte layers included in anode-supported cells obtained in Examples 1 and 2.

FIG. 4 shows an example of a scanning electron microscope image of a cross section of the anode-supported cell shown in FIG. 2, taken along the thickness direction of the anode-supported cell.

### DETAILED DESCRIPTION

The present invention relates to a production method for an anode-supported cell. The anode-supported cell is used in a fuel cell such as, for example, a SOFC. In the specification of the present application, the term “anode-supported cell” encompasses: an anode-supported cell according to an embodiment (i) in which a fuel electrode functions as a support layer; and an anode-supported cell according to an embodiment (ii) in which a support layer is provided separately from a fuel electrode. With production methods of the present invention, it is possible to easily produce the anode-supported cells according to the embodiments (i) and (ii).

Hereinafter, the present invention will be described based on preferred embodiments thereof with reference to the drawings.

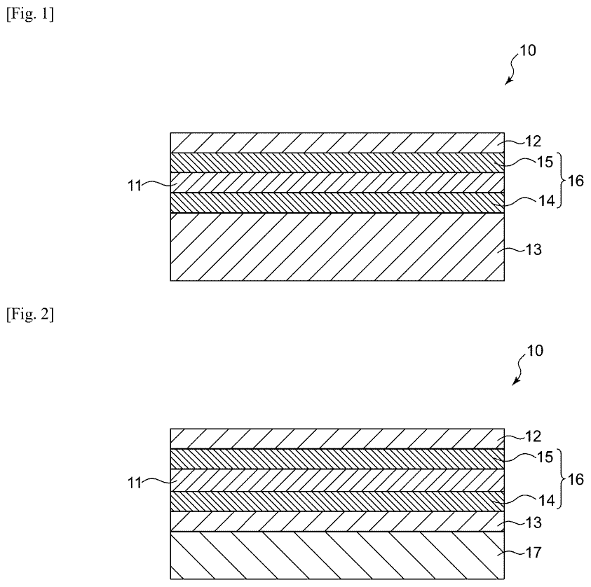

First, an anode-supported cell according to the embodiment (i) that is an anode-supported cell according to one embodiment produced using a method of the present invention will be described with reference to FIG. 1. An anode-supported cell 10 shown in the diagram includes a layer 11 that contains a solid electrolyte (hereinafter also referred to as “solid electrolyte layer 11”). The solid electrolyte layer 11 is made using a material that exhibits oxide ion conductivity at a predetermined temperature or more. The solid electrolyte layer 11 is provided between two electrodes, specifically, an air electrode 12 and a fuel electrode 13. That is, the air electrode 12 and the fuel electrode 13 are respectively provided on opposite sides of the solid electrolyte layer 11. In the anode-supported cell according to the present embodiment, the air electrode 12, the solid electrolyte layer 11, and the fuel electrode 13 are stacked in this order. The air electrode 12 may be electrically connected to a negative electrode of a DC power supply (not shown). On the other hand, the fuel electrode 13 may be electrically connected to a positive electrode of the DC power supply (not shown). Accordingly, DC voltage is applied across the air electrode 12 and the fuel electrode 13.

A first intermediate layer 14 is provided between the fuel electrode 13 and the solid electrolyte layer 11. On the other hand, a second intermediate layer 15 is provided between the air electrode 12 and the solid electrolyte layer 11. In FIG. 1, the fuel electrode 13 and the first intermediate layer 14 are illustrated as having the same width. However, the size relationship between the fuel electrode 13 and the first intermediate layer 14 is not limited thereto. For example, the fuel electrode 13 and the first intermediate layer 14 may have different sizes. The same applies to the air electrode 12 and the second intermediate layer 15. The air electrode 12 and the second intermediate layer 15 may have the same size. Alternatively, for example, the second intermediate layer 15 may be larger in size than the air electrode 12. Likewise, in FIG. 1, the first intermediate layer 14 and the solid electrolyte layer 11 are illustrated as having the same size. However, the size relationship between the first intermediate layer 14 and the solid electrolyte layer 11 is not limited thereto. For example, the solid electrolyte layer 11 and the first intermediate layer 14 may have different sizes. The same applies to the air electrode 12 side.

As shown in FIG. 1, the first intermediate layer 14 is in direct contact with the fuel electrode 13 and the solid electrolyte layer 11. Accordingly, there is no layer between the first intermediate layer 14 and the fuel electrode 13. In addition, the first intermediate layer 14 is also in direct contact with the solid electrolyte layer 11, and there is no layer between the first intermediate layer 14 and the solid electrolyte layer 11. The same applies to the air electrode 12 side. The second intermediate layer 15 is in direct contact with the solid electrolyte layer 11 and the air electrode 12.

The first intermediate layer 14 and the second intermediate layer 15 (hereinafter, for the sake of convenience, these layers may be collectively referred to simply as “intermediate layer 16”) are used for the purpose of improving the oxide ion conductivity between the solid electrolyte layer 11 and the air electrode 12 and/or the fuel electrode 13 in the anode-supported cell 10. In order to reduce the electric resistance of the anode-supported cell 10, it is important to enhance the oxide ion conductivity of the solid electrolyte layer 11. Even when the solid electrolyte layer 11 is configured using a highly oxide ion conductive material, if the oxide ion conductivity between the solid electrolyte layer 11 and the fuel electrode 13 and/or the air electrode 12 is low, there is a limit to enhancing the oxide ion conductivity of the anode-supported cell 10 as a whole. The inventor of the present application found, as a result of studies, that, when the air electrode 12, the fuel electrode 13, the solid electrolyte layer 11, and the intermediate layer 16 contain the same rare earth element (hereinafter also referred to as “common rare earth element”), the oxide ion conductivity of the anode-supported cell 10 as a whole can be enhanced, and a high level of power generation characteristics can be obtained. Although the reason is not clearly known, the inventor of the present application considers the reason as follows. However, the reason is not limited to theory given below.

The inventor of the present application suspects that, when the air electrode 12 and the fuel electrode 13 of the anode-supported cell 10 contain, for example, the same or different types of oxides represented by the following general formula: ABO_{3-δ}, which will be described later, the common rare earth element may be present in a portion of the A-site, and thus a path through which oxide ions can easily migrate may be likely to be formed in the oxide. Also, the inventor of the present application considers that, when the air electrode 12 and the fuel electrode 13 contain the same type of oxide represented by the general formula: ABO_{3-δ}, the path is more likely to be formed, and, by using lanthanum as the common rare earth element, the path is even more likely to be formed.

From the viewpoint of making the above-described advantageous effect obtained from the common rare earth element more prominent, it is preferable to use lanthanum as the common rare earth element. Furthermore, from the viewpoint of improving the oxide ion conductivity of the anode-supported cell 10, it is preferable that all of the air electrode 12, the fuel electrode 13, the solid electrolyte layer 11, and the intermediate layer 16 contain an oxide. In summary, it is preferable that all of the air electrode 12, the fuel electrode 13, the solid electrolyte layer 11, and the intermediate layer 16 contain an oxide of the common rare earth element.

Hereinafter, the solid electrolyte layer 11, the intermediate layer 16, the fuel electrode 13, and the air electrode 12 will be described in detail.

The solid electrolyte layer 11 is a conductor in which oxide ions function as carriers. As the solid electrolyte contained in the solid electrolyte layer 11, a monocrystalline material or a polycrystalline material is used. In particular, it is preferable to use an oxide of the common rare earth element as the solid electrolyte because the oxide ion conductivity can be enhanced more.

Also, from the viewpoint of even more enhancing the oxide ion conductivity of the anode-supported cell 10, the solid electrolyte preferably contains a composite oxide.

In the case where lanthanum is used as the common rare earth element, the oxide of the common rare earth element may be, for example, a composite oxide that contains lanthanum and silicon, a composite oxide that contains lanthanum and gallium, a composite oxide obtained by adding strontium, magnesium, cobalt, or the like to a composite oxide that contains lanthanum and gallium, a composite oxide that contains lanthanum and molybdenum, or the like.

Alternatively, in the case where samarium is used as the common rare earth element, the oxide of the common rare earth element may be, for example, a composite oxide that contains samarium and cerium, or the like.

Out of these oxides of the common rare earth element, from the viewpoint of further improving the oxide ion conductivity of the solid electrolyte layer 11 and enhancing the power generation characteristics of the anode-supported cell 10, it is preferable to use an oxide ion conductive material made of a composite oxide of lanthanum and silicon.

The composite oxide of lanthanum and silicon may be, for example, an apatite composite oxide that contains lanthanum and silicon and has an apatite crystal structure. From the viewpoint of further improving the oxide ion conductivity of the solid electrolyte layer 11 and enhancing the power generation characteristics of the anode-supported cell 10, as the apatite composite oxide, it is preferable to use an apatite composite oxide that contains lanthanum, which is a trivalent element, silicon, which is a tetravalent element, and O, and has a composition represented by the following general formula: LaₓSi₆O_{1.5x+12}, where X represents a number of 8 or more and 10 or less. The most preferable composition of the apatite composite oxide is La_{9.33}Si₆O₂₆. In the case where the apatite composite oxide is used as the solid electrolyte, it is preferable to cause the c-axis to coincide with the thickness direction of the solid electrolyte layer 11. The composite oxide can be produced in accordance with the method disclosed in, for example, JP 2013-51101A.

As another example of the solid electrolyte, a composite oxide represented by the following general formula: A_{9.33+x}[T_{6.00}]O_{26.00+z} may be used. This composite oxide also has an apatite crystal structure. In the general formula, A represents one or more elements selected from the group consisting of La, Ce, Nd, and Sm, and T represents Si. From the viewpoint of enhancing the c-axis orientation, it is preferable that A represents one or more elements selected from the group consisting of La, Ce, and Sm.

From the viewpoint of enhancing the degree of orientation and the oxide ion conductivity, x in the general formula is preferably −1.33 or more and 3.00 or less, more preferably 0.00 or more and 2.50 or less, and even more preferably 0.45 or more and 1.50 or less. From the viewpoint of maintaining electroneutrality in the apatite crystal lattice, z in the general formula is preferably −5.00 or more and 5.20 or less, more preferably −2.00 or more and 1.50 or less, and even more preferably −1.00 or more and 1.00 or less.

From the viewpoint of maintaining spatial occupancy in the apatite crystal lattice, in the general formula, the ratio (A/T) of the number of moles of A relative to the number of moles of T, or in other words, (9.33+x)/(6.00) in the general formula is preferably 1.33 or more and 3.61 or less, more preferably 1.40 or more and 3.00 or less, and even more preferably 1.50 or more and 2.00 or less.

Out of the composite oxides represented by the general formula, it is preferable to use a composite oxide in which A contains lanthanum, from the viewpoint of further improving the oxide ion conductivity of the solid electrolyte layer 11 and enhancing the power generation characteristics of the anode-supported cell 10. Specific examples of the composite oxide in which A contains lanthanum include: (LaₐSm_{b}Ce_{c})_{9.33+x}[Si_{6.00}]O_{26.00}, where 0.95<a+b+c<1.05; (LaₐCe_{b})_{9.33+z}[Si_{6.00}]O_{26.00}, where 0.95<a+b<1.05; (LaₐSm_{b})_{9.33+x}[Si_{6.00}]O_{26.00}, where 0.95<a+b<1.05; (LaₐNd_{b}Sm_{c})_{9.33+x}[Si_{6.00}]O_{26.00+z}, where 0.95<a+b+c<1.05; (LaₐNd_{b})_{9.33+x}[Si_{6.00}]O_{26.00+z}, where 0.95<a+b<1.05; and the like. The composite oxides represented by the general formulas can be produced in accordance with the method disclosed in, for example, WO 2016/111110.

The content ratio of metal elements in the solid electrolyte layer 11 can be determined based on, for example, energy dispersive X-ray spectroscopy (EDS). The same applies to the content ratio of metal elements in each of the layers included in the anode-supported cell 10 other than the solid electrolyte layer 11.

In the case where the anode-supported cell 10 is produced using a production method described later, the solid electrolyte contained in the solid electrolyte layer 11 has a particularly excellent c-axis orientation, and the oxide ion conductivity of the solid electrolyte layer 11 is improved. In the specification of the present application, the term “c-axis oriented” means that, in the case where the apatite composite oxide is polycrystalline, the crystal axes are aligned along the c-axis. Furthermore, in the case where the apatite composite oxide is present in the form of a monocrystal, the c-axis direction of the monocrystal can be caused to coincide with the oxide ion conduction direction in the anode-supported cell 10.

Whether the solid electrolyte is c-axis oriented can be determined by checking whether c-axis orientation degree f calculated based on the following formula (1) is preferably 0.50 or more, more preferably 0.60 or more, and even more preferably 0.65 or more. The higher the c-axis orientation degree f, the more preferable. However, the proportion is practically, for example, 0.99 or less.

The c-axis orientation degree f of the solid electrolyte can be calculated based on the Lotgering method. Specifically, the c-axis orientation degree f can be calculated based on the following formula (1) using the ratio ρ of the sum (ΣI(001)) of intensities of peaks attributed to the (002) plane and the (004) plane of the solid electrolyte relative to the total sum (ΣI(hkl)) of intensities of all peaks obtained by subjecting the solid electrolyte to X-ray diffraction (hereinafter also referred to as “XRD”). The reason that the (002) plane and the (004) plane are used is that the peaks attributed to the (002) plane and the (004) plane are peaks that are specific to the c-axis orientation, and are independent peaks that do not overlap with diffraction angle values attributed to other planes.

$$c - axis orientation degree f = ( ρ - {ρ}_{0} ) / ( 1 - {ρ}_{0} ) , \qquad ( 1 )$$

$$where {ρ}_{0} and ρ are values described below ,$$

$${ρ}_{0} : theoretical value ,$$

$${ρ}_{0} = \sum {I}_{0} ( 001 ) / \sum {I}_{0} ( hkl ) ,$$

$$ρ : measurement value , and$$

$$ρ = \sum I ( 001 ) / \sum I ( hkl ) .$$

Alternatively, whether the solid electrolyte is c-axis oriented can be determined by checking whether the proportion of crystals that have a deviation angle within 20 degrees relative to the c-axis orientation of the solid electrolyte determined through EBSD crystal orientation analysis is preferably 40% or more, more preferably 50% or more, and even more preferably 60% or more. The higher the proportion, the more preferable. However, the proportion is practically, for example, 90% or less.

From the viewpoint of effectively reducing the electric resistance of the anode-supported cell 10, the solid electrolyte layer 11 has a thickness of preferably 10 nm or more, more preferably 100 nm or more, and even more preferably 1000 nm or more. From the same viewpoint, the solid electrolyte layer 11 has a thickness of preferably 30 μm or less, more preferably 20 μm or less, and even more preferably 15 μm or less.

The thickness of the solid electrolyte layer 11 can be determined using, for example, a stylus-type step gauge or an electron microscope.

As described above, the intermediate layer 16 is a layer that improves the oxide ion conductivity of the solid electrolyte layer 11. From the viewpoint of making this advantageous effect more prominent, the intermediate layer 16 preferably contains a cerium oxide (hereinafter also referred to as “La-Ln¹DC”) that contains lanthanum and an Ln element, where Ln represents a rare earth element other than cerium. In this case, the rare earth element other than cerium corresponds to the common rare earth element. La-Ln¹DC is an oxide in which a rare earth element other than cerium is contained (doped) in the form of a solid solution in the cerium oxide (CeO₂) that is the base material. The rare earth element used as the doping element is usually present in a site where cerium is present in the crystal lattice of the cerium oxide such that it replaces the site where cerium is present. Lanthanum is contained in the solid solution of the cerium oxide. That is, lanthanum may be present in a site where cerium is present in the crystal lattice of the cerium oxide such that it replaces the site where cerium is present, or may be present in the grain boundaries in the cerium oxide doped with the Ln element.

In La-Ln¹DC that constitutes the intermediate layer 16, the Ln element doped in the cerium oxide may be, for example, La, Nd, Sm, Gd, Y, Er, Yb, Dy, or the like. These elements listed as examples of the Ln element may be used alone or in a combination of two or more. In other words, the intermediate layer 16 can contain cerium oxide whose Ln element is at least one selected from the group consisting of La, Nd, Sm, Gd, Y, Er, Yb, and Dy. In particular, it is preferable that the intermediate layer 16 contains cerium oxide whose Ln element is at least one selected from the group consisting of La, Nd, and Sm, from the viewpoint of further improving the oxide ion conductivity of the solid electrolyte layer 11, and thereby further improving the oxide ion conductivity of the anode-supported cell 10 as a whole. The two intermediate layers 14 and 15 may contain the same type or different types of La-Ln¹DC. Also, one of the first intermediate layer 14 and the second intermediate layer 15 may contain La-Ln¹DC, and the other one may be composed of a different substance.

In La-Ln¹DC, the proportion of the Ln element doped in cerium oxide, which is expressed by Ln¹/Ce that is the atomic ratio of the Ln element (Ln¹) relative to cerium, is preferably 0.050 or more and 0.50 or less, more preferably 0.10 or more and 0.40 or less, and even more preferably 0.20 or more and 0.30 or less. By setting the degree of doping of the Ln element within the above-described range, the oxide ion conductivity between the solid electrolyte layer 11 and the air electrode 12 and/or the fuel electrode 13 can be improved.

The value of the ratio Ln¹/Ce is determined based on energy dispersive X-ray spectroscopy (EDS), an electron probe microanalyzer (EPMA), or the like. Also, whether the Ln element is contained in the form of a solid solution in the cerium oxide is determined based on X-ray diffractometry.

In La-Ln¹DC that constitutes the first intermediate layer 14, lanthanum is contained for the purpose of further improving the oxide ion conductivity of the solid electrolyte layer 11 and thereby further improving the oxide ion conductivity of the anode-supported cell 10 as a whole. For this purpose, the value of La/Ce that is the atomic ratio of lanthanum relative to cerium in La-Ln¹DC is preferably set to 0.10 or more. When too much lanthanum is contained, it conversely causes a decrease in the oxide ion conductivity. Accordingly, the value of the ratio La/Ce is preferably set to 1.2 or less. From these viewpoints, the value of the ratio La/Ce is set to more preferably 0.20 or more and 1.0 or less, and even more preferably 0.25 or more and 0.80 or less. The value of the ratio La/Ce is determined based on energy dispersive X-ray spectroscopy (EDS), an electron probe microanalyzer (EPMA), or the like.

The inventor of the present application found, as a result of studies, that the oxide ion conductivity between the solid electrolyte layer 11 and the air electrode 12 and/or the fuel electrode 13 can be effectively improved by configuring the intermediate layer 16 to have a predetermined thickness. More specifically, as the thickness of the intermediate layer 16, the first intermediate layer 14 and the second intermediate layer 15 each independently have a thickness of preferably 10 nm or more, more preferably 100 nm or more, and even more preferably 1 μm or more. For the same reason, the first intermediate layer 14 and the second intermediate layer 15 each independently have a thickness of preferably 30 μm or less, more preferably 20 μm or less, and even more preferably 10 m or less. The thickness of the intermediate layer 16 can be measured using a stylus-type step gauge, an electron microscope, or the like. The first intermediate layer 14 and the second intermediate layer 15 may have the same thickness or different thicknesses.

The fuel electrode 13 according to the present embodiment is a layer that functions not only as an electrode, but also as a support layer that increases the mechanical strength of the anode-supported cell 10. For this purpose, the fuel electrode 13 is relatively thicker than that of an ordinary electrode. As a result of the anode-supported cell 10 including the fuel electrode 13 configured as described above, the mechanical strength of the anode-supported cell 10 can be increased. Due to this, as compared with the case where the anode-supported cell 10 includes an ordinary electrode that has a relatively small electrode thickness, the thicknesses of the air electrode 12, the solid electrolyte layer 11, and the intermediate layer 16 can be reduced. As a result, according to the present embodiment, it is possible to achieve an anode-supported cell 10 that has an excellent mechanical strength and excellent durability and in which the reduction in the oxide ion conductivity is suppressed.

From the viewpoint of making the above-described advantageous effect more prominent, the thickness of the fuel electrode 13 is preferably 300 μm or more, more preferably 750 μm or more, and even more preferably 1000 μm or more. From the same viewpoint, the thickness of the fuel electrode 13 is preferably 3000 μm or less, more preferably 2500 μm or less, and even more preferably 2000 μm or less.

The thickness of the fuel electrode 13 can be measured using a stylus-type step gauge, an electron microscope, or the like.

As described above, the air electrode 12 and the fuel electrode 13 that are in direct contact with the intermediate layer 16 preferably contain a common rare earth element and an oxide ion conductive oxide. In addition thereto, the air electrode 12 and the fuel electrode 13 may each independently further contain a metal material. As the metal material, nickel or a platinum group element is preferably used because they have an advantage such as high catalytic activity. More preferably, nickel is used. Examples of the platinum group element include platinum, ruthenium, rhodium, palladium, osmium, iridium, and the like. These elements can be used alone or in a combination of two or more. Alternatively, the fuel electrode 13 and the air electrode 12 may each independently contain a cermet that contains an oxide that contains the common rare earth element and the metal material.

As the oxide contained in the air electrode 12 and the fuel electrode 13, an oxide (hereinafter also referred to as “oxide a”) that has a perovskite structure represented by the general formula: ABO_{3-δ} is preferably used. In the general formula, A represents an alkaline earth metal element and contains, in part, the common rare earth element. In the general formula, B represents a transition metal element such as, for example, Ti, V, Cr, Mn, Fe, Co, Ni, Cu, Zn, Y, Zr, Nb, Mo, Tc, Ru, Rh, Pd, Ag, Ta, or W. In the general formula, δ represents a fraction generated by the valence and the content of A, B, and O. Various types of oxides that have a perovskite structure represented by the general formula: ABO_{3-δ} are known, and it is also known that these oxides have various types of crystal systems such as, for example, cubic, tetragonal, rhombohedral, and orthorhombic. Out of these crystal systems, it is preferable to use an ABO_{3-δ} oxide that has a cubic perovskite structure as the air electrode 12 and/or the fuel electrode 13. By configuring the anode-supported cell 10 by bonding the air electrode 12 and/or the fuel electrode 13 made using the above-described oxide directly to the intermediate layer 16 made using the above-described material, the oxide ion conductivity of the anode-supported cell 10 as a whole can be further improved.

The content of the common rare earth element in the oxide a, which is expressed by the atomic ratio of lanthanum relative to all elements present in the A-site, is preferably 0.010 or more and 0.80 or less, more preferably 0.050 or more and 0.80 or less, even more preferably 0.10 or more and 0.70 or less, yet even more preferably 0.15 or more and 0.70 or less, and most preferably 0.15 or more and 0.60 or less. In the case where the content of the common rare earth element in the oxide a is within the above-described range, the oxide ion conductivity of the oxide a can be improved. Although the reason is not clearly known, the inventor of the present application suspects that, as a result of the common rare earth element being contained in a portion of the A-site, a path through which oxide ions can easily migrate may be formed in the oxide a. However, the reason is not limited to this theory.

Whether the common rare earth element is present in a portion of the A-site in the oxide a can be checked based on X-ray diffractometry. Also, the proportion of lanthanum relative to all elements present in the A-site can be determined based on energy dispersive X-ray spectroscopy (EDS), an electron probe microanalyzer (EPMA), ICP optical emission spectroscopy, or the like.

In the case where the oxide a is used as a material for constituting the air electrode 12, the alkaline earth metal element that occupies the A-site is preferably at least one selected from the group consisting of barium and strontium, from the viewpoint of improving the oxide ion conductivity of the anode-supported cell 10 as a whole. That is, it is preferable that at least lanthanum and at least one selected from the group consisting of barium and strontium are present in the A-site of the oxide a.

The transition metal element that occupies the B-site of the oxide a preferably contains, in part, at least one of elements that belong to the fourth and fifth periods in the periodic table. In particular, the transition metal element present in the B-site preferably contains at least one selected from the group consisting of iron, cobalt, nickel, copper, titanium, zirconium, and niobium. Furthermore, from the viewpoint of improving the oxide ion conductivity of the anode-supported cell 10 as a whole, it is more preferable that the transition metal element present in the B-site contains, in part, iron. From the same viewpoint, it is even more preferable that both iron and copper are present at least in part in the B-site.

In the case where iron is present in the B-site of the oxide a, from the viewpoint of improving the oxide ion conductivity of the anode-supported cell 10 as a whole and not affecting the crystal systems of the oxide a, the atomic ratio of iron relative to all elements present in the B-site is preferably 0.05 or more and 0.95 or less, more preferably 0.10 or more and 0.90 or less, and even more preferably 0.20 or more and 0.80 or less. Also, in the case where iron and copper are present in the B-site of the oxide a, the total atomic ratio of iron and copper relative to all elements present in the B-site is preferably 0.80 or more and 1.00 or less, more preferably 0.85 or more and 1.00 or less, and even more preferably 0.90 or more and 1.00 or less. In this case, the value of Fe/Cu that is the atomic ratio of iron relative to copper is preferably 1.00 or more and 10.0 or less, more preferably 2.00 or more and 9.50 or less, and even more preferably 5.00 or more and 9.00 or less. The value of the atomic ratio Fe/Cu can be determined based on energy dispersive X-ray spectroscopy (EDS), an electron probe microanalyzer (EPMA), ICP optical emission spectroscopy, or the like. Also, whether iron is present in the B-site of the oxide a can be checked based on X-ray diffractometry.

An oxide represented by the following general formula: La₁₋ₓAₓBO_{3-δ}, is preferably used as the oxide a, where A represents either one or both elements of Ba and Sr, and B represents one or more elements selected from the group consisting of Fe, Cu, Ti, Zr, and Nb. In particular, it is preferable that B represents one or more elements selected from the group consisting of Fe, Cu, and Zr. In the general formula, x represents a number of 0.01 or more and 0.80 or less.

Oxides more preferably used as the oxide a are oxides (i) to (iv) shown below:
(i) an oxide in which the A-site is occupied by lanthanum and strontium, and the B-site is occupied by iron and cobalt;
(ii) an oxide in which the A-site is occupied by lanthanum and strontium, and the B-site is occupied by iron, cobalt, and nickel;
(iii) an oxide in which the A-site is occupied by lanthanum and barium and, the B-site is occupied by iron; and
(iv) an oxide in which the A-site is occupied by lanthanum and barium, and the B-site is occupied by iron and copper.

The oxide a can be obtained based on a breakdown method in which particles are pulverized into fine particles by mechanical energy, a build-up method in which the growth of atomic or molecular aggregates is controlled by a chemical reaction, or the like. From the viewpoint of reducing the electric resistance, it is preferable to use the build-up method. With the build-up method, fine particles can be easily obtained, and the contact area between particles can be increased. Accordingly, it is considered that the above-described advantageous effect can be obtained. Specifically, the oxide a can be obtained using, for example, the method described below. Specifically, acetates or nitrates of metals mixed at a stoichiometric ratio according to the intended composition of the oxide with a perovskite structure are dissolved in ion exchange water together with DL-malic acid, and ammonia water is added to the mixture while stirring the mixture to adjust the pH to 5 to 6. After that, the solution is evaporated at 350° C., and the obtained powder is pulverized using a mortar. The powder obtained in the above-described manner is temporarily calcined in the air at a temperature of 700° C. to 1000° C. for 5 hours, and again pulverized. However, the method for producing the oxide a is not limited to this method.

In addition to the oxide a, an oxide preferably contained in the air electrode 12 and the fuel electrode 13 is La-Ln¹DC described above. For La-Ln¹DC contained in the air electrode 12 and the fuel electrode 13, the description of La-Ln¹DC contained in the intermediate layer 16 given above can be applied. Accordingly, only differences from La-Ln¹DC contained in the intermediate layer 16 will be described below.

In the case where La-Ln¹DC is contained in the fuel electrode 13, the value of La/Ce that is the atomic ratio of lanthanum relative to cerium is preferably 0.1 or more and 1.2 or less, more preferably 0.2 or more and 1.0 or less, and even more preferably 0.25 or more and 0.8 or less.

In particular, from the viewpoint of further improving the oxide ion conductivity of the solid electrolyte layer 11, and thereby further improving the oxide ion conductivity of the anode-supported cell 10 as a whole, it is preferable that the fuel electrode 13 contains cerium oxide whose Ln element is at least one selected from the group consisting of La, Nd, Sm, Gd, Y, Er, Yb, and Dy. Also, from the viewpoint of further improving the oxide ion conductivity of the solid electrolyte layer 11, and thereby enhancing the catalytic activity of the fuel electrode while further improving the oxide ion conductivity of the anode-supported cell 10 as a whole, it is more preferable that the fuel electrode 13 contains a cermet that contains La-Ln¹DC and nickel.

In the case where the fuel electrode 13 contains an oxide (hereinafter also referred to as “first oxide”) that contains the common rare earth element, and the solid electrolyte of the solid electrolyte layer 11 contains an oxide (hereinafter also referred to as “second oxide”) that contains the common rare earth element, it is preferable that the content of the common rare earth element in the first oxide and the content of the common rare earth element in the second oxide have a predetermined relationship. More specifically, the ratio of the number of moles of the common rare earth element relative to the total number of moles of elements other than an oxygen element in the first oxide is represented by n1, and the ratio of the number of moles of the common rare earth element relative to the total number of moles of elements other than an oxygen element in the second oxide is represented by n2. At this time, n1/n2 that is the ratio of the two ratios is preferably 0.30 or more, more preferably 0.35 or more, and even more preferably 0.40 or more. Also, the ratio n1/n2 is preferably 0.70 or less, more preferably 0.60 or less, and even more preferably 0.55 or less.

By setting the ratio n1/n2 within the above-described range, the oxide ion conductivity of the solid electrolyte layer 11 can be further improved, and thereby the oxide ion conductivity of the anode-supported cell 10 as a whole can be further improved. Accordingly, the power generation characteristics of the anode-supported cell 10 can be enhanced.

In the case where the fuel electrode contains a cermet that contains the first oxide and a metal material, the number of moles of metal elements contained in the metal material is not included in the calculation of “the total number of moles of elements other than an oxygen element” used in the calculation of the ratio n1. The same applies to the calculation of the ratio n2, as well as the calculation of ratios n3 to n6, which will be described later.

Also, from the viewpoint of further improving the oxide ion conductivity of the solid electrolyte layer 11, and thereby further improving the oxide ion conductivity of the anode-supported cell 10 as a whole, and enhancing the power generation characteristics of the anode-supported cell 10, the ratio n1 is preferably 8.0 mol % or more and 50 mol % or less, more preferably 9.0 mol % or more and 45 mol % or less, and even more preferably 10 mol % or more and 40 mol % or less.

From the same viewpoint, the ratio n2 is preferably 45 mol % or more and 80 mol % or less, more preferably 50 mol % or more and 75 mol % or less, and even more preferably 55 mol % or more and 70 mol % or less.

From the same viewpoint, in the case where the air electrode 12 contains an oxide that contains the common rare earth element, n3 that is the ratio of the number of moles of the common rare earth element relative to the total number of moles of elements other than an oxygen element in the oxide is preferably 20 mol % or more and 40 mol % or less, more preferably 25 mol % or more and 38 mol % or less, and even more preferably 30 mol % or more and 35 mol % or less.

Also, in the case where the second intermediate layer 15 contains an oxide that contains the common rare earth element, n4 that is the ratio of the number of moles of the common rare earth element relative to the total number of moles of elements other than an oxygen element in the oxide is preferably 3 mol % or more and 27 mol % or less, more preferably 5 mol % or more and 25 mol % or less, and even more preferably 6 mol % or more and 20 mol % or less.

Also, in the case where the first intermediate layer 14 contains an oxide that contains the common rare earth element, n5 that is the ratio of the number of moles of the common rare earth element relative to the total number of moles of elements other than an oxygen element in the oxide is preferably 3 mol % or more and 50 mol % or less, more preferably 10 mol % or more and 40 mol % or less, and even more preferably 15 mol % or more and 35 mol % or less.

In the anode-supported cell 10 according to the present embodiment, only one of the ratios n1 to n5 may be within the above-described preferred numerical value range, or a combination of any two or more of the ratios n1 to n5 may be within the above-described preferred numerical value range.

From the viewpoint of enhancing the oxide ion conductivity of the anode-supported cell 10 as a whole and enhancing the power generation characteristics of the anode-supported cell 10, n4/n2 that is the ratio of n4 relative to n2 is preferably 0.001 or more, more preferably 0.005 or more, even more preferably 0.01 or more, and yet even more preferably 0.08 or more. From the same viewpoint, the ratio n4/n2 is preferably 0.6 or less, more preferably 0.45 or less, even more preferably 0.3 or less, and yet even more preferably 0.2 or less.

From the viewpoint of enhancing the oxide ion conductivity of the anode-supported cell 10 as a whole and enhancing the power generation characteristics of the anode-supported cell 10, n5/n2 that is the ratio of n5 relative to n2 is preferably 0.070 or more, more preferably 0.20 or more, and even more preferably 0.27 or more. From the same viewpoint, the ratio n5/n2 is preferably 0.70 or less, more preferably 0.65 or less, and even more preferably 0.60 or less.

From the viewpoint of reducing the electric resistance, the oxides contained in the air electrode 12 and the fuel electrode 13 each independently have an average particle size of 1000 nm or less, preferably 600 nm or less, more preferably 300 nm or less, and even more preferably 200 nm or less. From the same viewpoint, the oxides contained in the air electrode 12 and the fuel electrode 13 have an average particle size of 1 nm or more, preferably 2 nm or more, and more preferably 3 nm or more. The average particle size can be calculated using an image of particles obtained from a scanning electron microscope and known image analysis software. For example, the average particle size can be calculated by observing ten arbitrarily selected particles at a magnification of 1000 to 100000 times to determine the contours of the particles, optionally performing processing such as enhancing contrast or drawing lines along the contours, and thereafter performing image analysis.

It is preferable that the air electrode 12 has a predetermined thickness from the viewpoint of further improving the oxide ion conductivity of the solid electrolyte layer 11, and thereby even more effectively improving the oxide ion conductivity of the anode-supported cell 10 as a whole. More specifically, the thickness of the air electrode 12 that is bonded to the intermediate layer 16 is preferably 100 nm or more, more preferably 200 nm or more, even more preferably 500 nm or more, yet even more preferably 1 μm or more, and particularly preferably 5 μm or more. From the same viewpoint, the thickness of the air electrode 12 is preferably 25 μm or less, more preferably 20 μm or less, even more preferably 15 μm or less, and yet even more preferably 10 μm or less. The thickness of the air electrode 12 can be measured using a stylus-type step gauge, an electron microscope, or the like.

Next, an anode-supported cell according to the embodiment (ii) that is an anode-supported cell according to another embodiment produced using a method of the present invention will be described with reference to FIG. 2. The anode-supported cell according to the embodiment (ii) shown in FIG. 2 will be described focusing on differences from the constituent members of the anode-supported cell 10 shown in FIG. 1, and constituent members that are the same as those of the anode-supported cell 10 are given the same reference numerals, and a description thereof will be omitted. For the constituent elements of the anode-supported cell according to the embodiment (ii) shown in FIG. 2 that are not specifically described in the following description, the description of those of the anode-supported cell 10 shown in FIG. 1 is applied as appropriate.

An anode-supported cell 10 shown in FIG. 2 further includes a support layer 17 in addition to the fuel electrode 13. The support layer 17 is provided on a side of the fuel electrode 13 opposite to another side of the fuel electrode 13 that faces the solid electrolyte layer 11. The support layer 17 is in direct contact with the fuel electrode 13. Accordingly, there is no layer between the support layer 17 and the fuel electrode 13. In FIG. 2, the support layer 17 and the fuel electrode 13 are illustrated as having the same width. However, the size relationship between the support layer 17 and the fuel electrode 13 is not limited thereto. For example, the support layer 17 and the fuel electrode 13 may have different sizes. For example, the support layer 17 and the fuel electrode 13 may be sized such that the support layer 17 extends from the periphery of the fuel electrode 13.

The support layer 17 is a layer that functions to increase the mechanical strength of the anode-supported cell 10. In the anode-supported cell 10 shown in FIG. 1, this function is performed by the fuel electrode 13. However, in the anode-supported cell 10 according to the present embodiment, the support layer 17 is provided separately from the fuel electrode 13. For this reason, in the anode-supported cell 10 according to the present embodiment, the thickness of the fuel electrode 13 can be reduced as compared with that of the anode-supported cell 10 shown in FIG. 1. As a result of the anode-supported cell 10 including the support layer 17 configured as described above, the mechanical strength of the anode-supported cell 10 can be increased. Due to this, as compared with the case where the anode-supported cell 10 does not include the support layer 17, the thicknesses of the air electrode 12, the fuel electrode 13, the solid electrolyte layer 11, and the intermediate layer 16 can be reduced. As a result, according to the present embodiment, it is possible to achieve an anode-supported cell 10 that has an excellent mechanical strength and excellent durability and in which the reduction in the oxide ion conductivity is suppressed.

From the viewpoint of making the above-described advantageous effect more prominent, the thickness of the support layer 17 is preferably 200 μm or more, more preferably 300 μm or more, even more preferably 500 μm or more, and yet even more preferably 1000 μm or more. From the same viewpoint, the thickness of the support layer 17 is preferably 3000 μm or less, more preferably 2500 μm or less, and even more preferably 2000 μm or less.

In the present embodiment in which the anode-supported cell 10 includes the support layer 17, the thickness of the fuel electrode 13 can be reduced as compared with that of the embodiment shown in FIG. 1. Specifically, the thickness of the fuel electrode 13 can be set to 30 μm or less, preferably 25 μm or less, more preferably 20 μm or less, even more preferably 15 μm or less, and yet even more preferably 10 μm or less. Also, the thickness of the fuel electrode 13 can be set to 0.2 μm or more, preferably 0.5 μm or more, and more preferably 1.0 μm or more.

The thickness of the support layer 17 can be measured using a stylus-type step gauge, an electron microscope, or the like.

FIG. 4 shows an example of a scanning electron microscope (SEM) image of a cross section of the anode-supported cell 10 taken along the thickness direction of the anode-supported cell 10. In FIG. 4, the boundaries of the layers included in the anode-supported cell 10 are clearly observed. Accordingly, the thickness of each layer included in the anode-supported cell 10 can be measured using the SEM image.

It is preferable that the support layer 17 contains the above-described common rare earth element. With this configuration, in the anode-supported cell 10, the solid electrolyte layer 11 and the support layer 17 both contain the above-described common rare earth element, and thus the linear expansion coefficient of the solid electrolyte layer 11 and the linear expansion coefficient of the support layer 17 can be easily controlled to close values. As a result, it is possible to suppress cracking of the solid electrolyte layer 11 caused by the difference in linear expansion coefficient between the solid electrolyte layer 11 and the support layer 17 during use of the anode-supported cell 10.

In the case where the support layer 17 contains an oxide that contains the above-described common rare earth element, n6 that is the ratio of the number of moles of the common rare earth element relative to the total number of moles of elements other than an oxygen element in the oxide is preferably within a predetermined range. More specifically, from the viewpoint of further improving the oxide ion conductivity of the solid electrolyte layer 11, and thereby further improving the oxide ion conductivity of the anode-supported cell 10 as a whole, and enhancing the power generation characteristics of the anode-supported cell 10, the ratio n6 is preferably 9 mol % or more and 80 mol % or less, more preferably 10 mol % or more and 75 mol % or less, even more preferably 12 mol % or more and 70 mol % or less, yet even more preferably 30 mol % or more and 70 mol % or less, yet even more preferably 40 mol % or more and 70 mol % or less, and yet even more preferably 45 mol % or more and 65 mol % or less.

In the anode-supported cell 10 according to the present embodiment, only one of the ratios n1 to n5 and n6 may be within the above-described preferred numerical value range, or a combination of any two or more of the ratios n1 to n5, and n6 may be within the above-described preferred numerical value range.

As the oxide that contains the above-described common rare earth element contained in the support layer 17, for example, any of the various types of oxides listed above as examples of the solid electrolyte can be used. In addition thereto, the support layer 17 may further contain a metal material. As the metal material, nickel or a platinum group element is preferably used from the viewpoint of high catalytic activity and electron conductivity. More preferably, nickel is used. Alternatively, the support layer 17 may contain a cermet that contains any of the oxides listed above as examples of the solid electrolyte and the above-described metal material.

From the viewpoint of suppressing an increase in the electric resistance of current collection, the support layer 17 is preferably electroconductive.

Next, a production method according to the present invention will be described. The production method according to the present invention includes the steps of: preparing a first stacked body that is a material composition layer and heating the first stacked body at a predetermined temperature; obtaining a second stacked body in which a material composition layer is provided on a sintered first stacked body obtained by heating the first stacked body; and heating the second stacked body at a predetermined temperature.

According to the present invention, the anode-supported cell can be produced mostly by heating the stacked body that includes several types of layers. Accordingly, it is possible to more easily produce the anode-supported cells according to the embodiments (i) and (ii) described above as compared with the case where a conventional production method that requires each layer to be heated is used.

First, a production method for an anode-supported cell (i) whose fuel electrode functions as a support layer will be described.

As a first stacked body, a green sheet is preferably used. The green sheet can be obtained by molding a slurry that contains a material composition for the anode-supported cell into a sheet. First, as the material composition, a material composition used to produce a solid electrolyte, a material composition used to produce a first intermediate layer, and a material composition used to produce a fuel electrode are prepared.

The material composition used to produce a solid electrolyte contains lanthanum and silicon. As the material composition, for example, an oxide represented by the following composition formula: La₂Si₂O₇ can be prepared.

The material composition used to produce a first intermediate layer contains the above-described common rare earth element, cerium, and oxygen. In the material composition, from the viewpoint of further improving the oxide ion conductivity of the anode-supported cell as a whole and enhancing the power generation characteristics of the anode-supported cell, it is preferable to use lanthanum as the common rare earth element. From the same viewpoint, the material composition is preferably doped with lanthanum. As the material composition, for example, a compound represented by the following composition formula: La_{0.5}Ce_{0.5}O_{1.75} can be prepared.

The material composition used to produce a fuel electrode contains the above-described common rare earth element, nickel, and oxygen. The nickel contained in the material composition functions as a reaction catalyst. As the material composition, for example, cerium oxide that is doped or not doped with nickel oxide (II) and an Ln element, where Ln represents a rare earth element other than Ce, can be prepared. Specifically, a compound represented by the following composition formula: La_{0.5}Ce_{0.5}O_{1.75} can be prepared.

Then, when the above-described material compositions have been prepared, each of the material compositions is mixed with a liquid such as water or an organic solvent to make a slurry of the material composition. Slurries are made for each of the material composition used to produce a solid electrolyte, the material composition used to produce a first intermediate layer, and the material composition used to produce a fuel electrode. As the organic solvent, for example, ethanol, isopropyl alcohol, toluene, or the like can be used. These organic solvents can be used alone or in a combination of two or more. The mixing can be performed using, for example, an ultrasonic homogenizer, a shaker, a thin-film swirl mixer, a dissolver, a homomixer, a kneader, a roll mill, a sand mill, an attritor, a ball mill, a vibrator mill, a high-speed impeller mill, or the like. During the mixing, optionally, for example, an additive such as a dispersant, a defoamer, a binder, or a plasticizer may be used. There is no particular limitation on the mixing time and mixing temperature. The mixing time and the mixing temperature can be adjusted as appropriate according to the type of material composition, the type of liquid, or the like.

After the slurry has been made, the slurry is molded into a sheet to obtain a green sheet. Molding is performed for each of the slurry for a solid electrolyte, the slurry for a first intermediate layer, and the slurry for a fuel electrode. Through molding, an oxide-containing layer (hereinafter also referred to simply as “oxide layer”) is obtained from the slurry for a solid electrolyte. A first layer is obtained from the slurry for a first intermediate layer. A nickel oxide-containing layer (hereinafter also referred to simply as “nickel oxide layer”) is obtained from the slurry for a fuel electrode.

The molding can be performed using various types of molding machines such as a film applicator, a doctor blade, a spray, and a spin coater.

It is preferable to mold each layer to have a predetermined thickness, from the viewpoint of efficiently obtaining a desired anode-supported cell by heating the first stacked body, which will be described later. Specifically, the thickness of the oxide layer is preferably 5 μm or more, and more preferably 10 μm or more. From the same viewpoint, the thickness of the oxide layer is preferably 40 μm or less, and more preferably 30 μm or less.

From the viewpoint of efficiently obtaining a desired anode-supported cell, the thickness of the first layer is preferably 10 μm or more, and more preferably 15 μm or more. From the same viewpoint, the thickness of the first layer is preferably 100 μm or less, and more preferably 80 μm or less.

From the viewpoint of efficiently obtaining a desired anode-supported cell, the thickness of the nickel oxide layer is preferably 300 μm or more, and more preferably 750 m or more. From the same viewpoint, the thickness of the nickel oxide layer is preferably 3000 μm or less, and more preferably 2500 μm or less.

The thickness of each layer can be adjusted as appropriate by changing the type of applicator or an applicator gap used during molding. The thickness of each layer can also be adjusted by changing the number of green sheets stacked. In this case, for example, green sheets, each having a thickness of 10 μm or more and 100 μm or less, are obtained, and then stacked to have a thickness within the above-described range.

Next, the obtained layers are stacked one by one, and then subjected to thermal press-bonding. Through this, a first stacked body is obtained. The oxide layer, the first layer, and the nickel oxide layer are stacked in an order corresponding to the order of the layers in the intended anode-supported cell. For example, in the case of producing an anode-supported cell whose fuel electrode functions as a support layer, in the stacked body, an oxide layer, a first layer that is provided on one side of the oxide layer, and a nickel oxide layer that is provided on a side of the first layer opposite to another side of the first layer that faces the oxide layer may be stacked.

The oxide layer, the first layer, and the nickel oxide layer may be in contact with each other at a portion or all of their facing regions. From the viewpoint of effectively generating a solid electrolyte that has an apatite structure and is c-axis oriented, it is preferable that the oxide layer, the first layer, and the nickel oxide layer are in contact with each other at all of their facing regions.

From the viewpoint of enhancing the adhesion between sheets by thermally softening the sheets, the heating temperature during thermal press-bonding is preferably 50° C. or more, more preferably 55° C. or more, and even more preferably 60° C. or more.

From the same viewpoint, the heating temperature is preferably 100° C. or less, more preferably 95° C. or less, and even more preferably 90° C. or less.

From the viewpoint of enhancing the adhesion between stacked sheets, the pressure applied during thermal press-bonding is preferably 0.1 MPa or more, more preferably 0.2 MPa or more, and even more preferably 0.3 MPa or more. From the same viewpoint, the pressure is preferably 10.0 MPa or less, more preferably 5.0 MPa or less, and even more preferably 3.0 MPa or less.

When a first stacked body has been obtained, the obtained first stacked body can be cut into a desired shape as needed. After that, the first stacked body is heated to obtain a sintered first stacked body. Through this heating, the elements diffuse between the oxide layer and the first layer, and a solid electrolyte that has an apatite structure and is c-axis oriented is generated from the oxide contained in the oxide layer. Specifically, SiO₂ is isolated from La₂Si₂O₇ contained in the oxide layer, and Si derived from the isolated SiO₂ diffuses from the oxide layer to the first layer. Along with this, La diffuses from the first layer to the oxide layer. In this way, a solid electrolyte composed of a composite oxide of lanthanum and silicon is generated. The content of La that diffuses from the oxide layer to the first layer through the heating is considered to be negligible.

The heating temperature for heating the first stacked body may be set to a value that allows the elements to diffuse between the oxide layer and the first layer. Specifically, the heating temperature is preferably 1000° C. or more, more preferably 1300° C. or more, and even more preferably 1500° C. or more. When the heating temperature is greater than or equal to the above-described values, Si effectively diffuses from the oxide layer to the first layer, and thereby the apatite structure is likely to be stabilized. For this reason, the higher the heating temperature, the more preferable. The intended advantageous effect can be sufficiently obtained even at a heating temperature of 1700° C. or less.

The heating time for heating the first stacked body may also be set to a value that allows the elements to diffuse between the oxide layer and the first layer. Specifically, the heating time is preferably 0.5 hours or more, more preferably 1 hour or more, and even more preferably 2 hours or more. For the same reason, the heating time is preferably 10 hours or less, more preferably 8 hours or less, and even more preferably 6 hours or less.

The heating can be performed using, for example, an electric furnace, a tubular furnace, or the like. As the atmosphere, an oxygen-containing atmosphere such as the air atmosphere, or an inert gas atmosphere such as a nitrogen gas atmosphere or an argon gas atmosphere can be used.

Through the heating performed in the above-described manner, a solid electrolyte layer, a first intermediate layer, and a fuel electrode that are included in an anode-supported cell are generated from the oxide layer, the first layer, and the nickel oxide layer, respectively.

Next, a material composition used to produce a second intermediate layer is prepared. The material composition contains the above-described common rare earth element, cerium, and oxygen. The material composition may be or may not be doped with an Ln element, where Ln represents a rare earth element other than Ce. In the case where the material composition is doped with an Ln element, as described above, the Ln element is preferably at least one selected from the group consisting of La, Nd, and Sm. As the material composition, cerium oxide that is doped or not doped with an Ln element, where Ln represents a rare earth element other than Ce, can be prepared. Specifically, a compound represented by the following composition formula: La_{0.5}Ce_{0.5}O_{1.75}, and Sm_{0.2}Ce_{0.8}O_{1.9} can be prepared.

When the material composition has been prepared, in the sintered first stacked body, a layer composed of the material for the second intermediate layer is placed on a side of the solid electrolyte-containing layer (or in other words, the solid electrolyte layer) opposite to another side of the solid electrolyte-containing layer that faces the sintered first layer. In this way, a second stacked body is obtained. The second stacked body can be obtained by forming a coating film by, for example, applying a slurry that contains the material composition. The slurry can be obtained by adding the material composition to, for example, a binder obtained by dissolving ethyl cellulose in a-terpineol, and then adjusting the concentration. When forming the coating film, the slurry and the solid electrolyte layer may be in contact with each other at a portion or all of their facing regions. From the viewpoint of further improving the oxide ion conductivity of the anode-supported cell as a whole and enhancing the power generation characteristics of the anode-supported cell, it is preferable that the slurry and the solid electrolyte layer are in contact with each other at all of their facing regions.

From the viewpoint of efficiently obtaining a desired anode-supported cell, it is preferable to form the coating film such that the resulting second layer has a thickness of 0.1 μm or more and 50 μm or less.

Next, the second stacked body is heated to obtain a sintered second stacked body. Through this heating, the elements diffuse between the solid electrolyte layer and the second layer, and it is therefore possible to cause the common rare earth element to be contained in the entire anode-supported cell.

Specifically, in the case where the material composition for the second intermediate layer contains lanthanum alone as the common rare earth element, Si derived from the composite oxide contained in the solid electrolyte layer diffuses from the solid electrolyte layer to the second layer. Along with this, La diffuses from the second layer to the solid electrolyte layer. The content of the common rare earth element in each of the layers that are included in the anode-supported cell is thereby well balanced. As a result, the oxide ion conductivity of the anode-supported cell as a whole can be further improved, and the power generation characteristics of the anode-supported cell can be enhanced. In this case, the amount of La that diffuses from the solid electrolyte layer to the second layer during heating is considered to be negligible.

Also, in the case where the material composition for the second intermediate layer contains samarium alone as the common rare earth element, La derived from the composite oxide contained in the solid electrolyte layer diffuses from the solid electrolyte layer to the second layer. Along with this, Sm diffuses from the second layer to the solid electrolyte layer. It is thereby possible to cause the common rare earth element to be contained in the entire anode-supported cell. As a result, the oxide ion conductivity of the anode-supported cell as a whole can be further improved, and the power generation characteristics of the anode-supported cell can be enhanced.

The heating temperature for heating the second stacked body may be set to a value that allows the elements to diffuse between the solid electrolyte layer and the second layer. Specifically, the heating temperature is preferably 1000° C. or more, more preferably 1150° C. or more, and even more preferably 1300° C. or more. When the heating temperature is greater than or equal to the above-described values, Si or La effectively diffuse between the solid electrolyte layer and the second layer, and it is thereby possible to cause the common rare earth element to be contained in the entire anode-supported cell. For this reason, the higher the heating temperature, the more preferable. The intended advantageous effect can be sufficiently obtained even at a heating temperature of 1700° C. or less.

The heating time for heating the second stacked body may be set to a value that allows the elements to diffuse between the solid electrolyte layer and the second layer. Specifically, the heating time is preferably 0.1 hours or more, more preferably 0.3 hours or more, and even more preferably 0.5 hours or more. For the same reason, the heating time is preferably 10 hours or less, more preferably 6 hours or less, and even more preferably 2 hours or less.

The heating can be performed using, for example, an electric furnace, a tubular furnace, or the like. As the atmosphere, an oxygen-containing atmosphere such as the air atmosphere, or an inert gas atmosphere such as a nitrogen gas atmosphere or an argon gas atmosphere can be used.

Through the heating performed in the above-described manner, a second intermediate layer that is included in the anode-supported cell is generated from the second layer.

Next, a material composition used to produce an air electrode is prepared. The material composition contains lanthanum. As the material composition, for example, a compound represented by the following composition formula: La_{0.6}Sr_{0.4}Co_{0.2}Fe_{0.8}O₃ can be prepared.

When the material composition has been prepared, in the sintered second stacked body, a layer composed of the material for the air electrode is placed on a side of the sintered second layer opposite to another side of the sintered second layer that faces the solid electrolyte layer. In this way, a third stacked body is obtained. The layer can be formed as a coating film by, for example, applying a slurry that contains the material composition. The slurry can be obtained by adding the material composition to, for example, a binder obtained by dissolving ethyl cellulose in a-terpineol, and then adjusting the concentration. When forming the coating film, the slurry and the sintered second layer may be in contact with each other at a portion or all of their facing regions. From the viewpoint of further improving the oxide ion conductivity of the anode-supported cell as a whole and enhancing the power generation characteristics of the anode-supported cell, it is preferable that the slurry and the sintered second layer are in contact with each other at all of their facing regions.

From the viewpoint of efficiently obtaining a desired anode-supported cell, it is preferable to form the coating film such that the resulting air electrode has a thickness of 1.0 μm or more and 30.0 μm or less.

Next, the third stacked body is heated to generate an air electrode. The heating temperature for heating the third stacked body is preferably lower than the heating temperatures for heating the first stacked body and the second stacked body. Through this heating, the diffusion of the elements between the solid electrolyte layer and the first layer and/or the second layer in the sintered third stacked body during calcination of the coating film can be suppressed, and thus a stable anode-supported cell can be produced. For this reason, the heating temperature for heating the third stacked body is set to, on the condition that it is lower than the heating temperatures for heating the first stacked body and the second stacked body, preferably 1600° C. or less, more preferably 1500° C. or less, and even more preferably 1400° C. or less. For the same reason, the heating temperature is preferably 600° C. or more, more preferably 700° C. or more, and even more preferably 800° C. or more.

The heating time for heating the third stacked body may be set to a value that allows the air electrode to be generated. Specifically, the heating time is preferably 0.1 hours or more, more preferably 0.3 hours or more, and even more preferably 0.5 hours or more. For the same reason, the heating time is preferably 10 hours or less, more preferably 9 hours or less, even more preferably 8 hours or less, yet even more preferably 5 hours or less, and yet even more preferably 2 hours or less. The heating time for heating the third stacked body may be the same as or different from the heating time for heating the first stacked body and/or the heating time for heating the second stacked body.

After that, as needed, the anode-supported cell may be subjected to reduction to reduce the metal oxide such as nickel oxide contained in the fuel electrode and a support layer, which will be described later, included in the anode-supported cell. Through this, for example, nickel oxide can be reduced to metallic nickel.

The reduction can be performed using, for example, hydrogen reduction. The hydrogen reduction can be performed under a condition commonly used in the technical field of the present application.

In this way, an anode-supported cell (i) whose fuel electrode functions as a support layer can be obtained.

Next, a production method for an anode-supported cell (ii) that includes a support layer that is provided separately from a fuel electrode will be described. In the following description, differences from the production method for an anode-supported cell (i) will be mainly described.

In this production method, in addition to the material compositions used to produce a solid electrolyte, a first layer, and a fuel electrode, a material composition used to produce a support layer is prepared.

The material composition used to produce a support layer contains lanthanum. As the material composition, for example, nickel oxide (II) and a compound represented by the following formula: La_{9.33}Si₆O₂₆ can be prepared.

When the material composition has been prepared, a slurry of the material composition is prepared. The slurry can be prepared using the same method as that used to produce the anode-supported cell (i) described above. A pore forming agent can be used as needed when preparing the slurry. The pore forming agent is thermally decomposed or sublimes at a certain temperature, and thus the support layer resulting from heating a green sheet that contains the pore forming agent has a large number of pores. With this configuration, gas diffusion can be easily performed. As the pore forming agent, for example, crosslinked polymethylmethacrylate particles can be used.

When the slurry has been prepared, the slurry is molded to obtain a green sheet. In this way, an auxiliary support layer can be obtained from the slurry of the material composition for the support layer. The molding can be performed using the same method as that used to produce the anode-supported cell (i) described above.

From the viewpoint of efficiently obtaining a desired anode-supported cell by heating a stacked body, which will be described later, it is preferable to mold the auxiliary support layer to have a predetermined thickness. Specifically, the auxiliary support layer has a thickness of preferably 200 μm or more, and more preferably 300 μm or more. From the same viewpoint, the auxiliary support layer has a thickness of preferably 3000 μm or less, and more preferably 2500 μm or less. In the case of adjusting the thickness by changing the number of green sheets stacked, for example, green sheets, each having a thickness of 10 μm or more and 300 μm or less, are obtained, and then stacked to have a thickness within the above described range.

Next, the prepared layers are stacked, and then subjected to thermal press-bonding. Through this, a first stacked body is obtained. In the embodiment (ii), the first stacked body is a stacked body in which the oxide layer, the first layer, the nickel oxide layer, and the auxiliary support layer are stacked. Note that the first stacked body of the embodiment (ii) is different from the first stacked body of the embodiment (i) in terms of configuration. The oxide layer, the first layer, the nickel oxide layer, and the auxiliary support layer are stacked in an order corresponding to the order of the layers in the intended anode-supported cell. For example, in the case of producing an anode-supported cell that includes a support layer that is provided separately from a fuel electrode, the following layers may be stacked to form a stacked body: an oxide layer, a first layer that is provided on one side of the oxide layer, a nickel oxide layer that is provided on a side of the first layer opposite to another side of the first layer that faces the oxide layer, and an auxiliary support layer that is provided on a side of the nickel oxide layer opposite to another side of the nickel oxide layer that faces the first layer.

The oxide layer, the first layer, the nickel oxide layer, and the auxiliary support layer may be in contact with each other at a portion or all of their facing regions. From the viewpoint of effectively generating a solid electrolyte that has an apatite structure and is c-axis oriented, it is preferable that the oxide layer, the first layer, the nickel oxide layer, and the auxiliary support layer are in contact with each other at all of their facing regions.

When a first stacked body has been obtained, the obtained first stacked body can be cut into a desired shape as needed. After that, the first stacked body is heated to obtain a sintered first stacked body. Through this heating, a solid electrolyte layer, a first intermediate layer, a fuel electrode, and a support layer that are included in the anode-supported cell are generated from the oxide layer, the first layer, the nickel oxide layer, and the auxiliary support layer, respectively.

When the sintered first stacked body has been obtained, a second intermediate layer can be formed using the same method as that used to produce the anode-supported cell (i) described above. After that, an air electrode can be formed using the same method as that used to produce the anode-supported cell (i) described above.

In this way, an anode-supported cell (ii) that includes a support layer that is provided separately from a fuel electrode can be obtained.

The anode-supported cell (i) and the anode-supported cell (ii) obtained in the above-described manner can be used in, for example, a SOFC, a solid oxide electrolysis cell (SOEC), an oxygen permeable element, a gas sensor, or the like.

Each of the anode-supported cells can be operated in, for example, the following manner. Specifically, first, hydrogen, methane, propane, a biogas, or the like is supplied to the fuel electrode, and air is supplied to the air electrode. In this state, the anode-supported cell is heated to, for example, a temperature of 600° C. or more and 1000° C. or less to activate the anode-supported cell.

Up to here, the present invention has been described based on preferred embodiments thereof. However, the present invention is not limited to the embodiments given above. For example, in the embodiments given above, the second stacked body is obtained by applying the slurry of the material composition for the second layer. However, instead, the second stacked body may be obtained by obtaining green sheets for the second layer and stacking the green sheets. Also, in the embodiments given above, the third stacked body is obtained by applying the slurry of the material composition for the air electrode, but instead, the third stacked body may be obtained by obtaining green sheets for the air electrode and stacking the green sheets.

In the embodiments given above, the first stacked body that includes the oxide layer, the first layer, and the nickel oxide layer, or the first stacked body that includes the oxide layer, the first layer, the nickel oxide layer, and the auxiliary support layer was heated all together. However, the oxide layer, the first layer, the nickel oxide layer, and/or the auxiliary support layer may be sequentially heated.

Regarding the embodiments given above, the following methods for producing an anode-supported cell are further disclosed.
[1] A production method for producing an anode-supported cell,
   the method comprising:
      a step of heating a first stacked body, in which a layer, a first layer and a nickel oxide-containing layer are stacked, at 1000° C. or more,
         wherein the layer contains an oxide represented by a composition formula: La₂Si₂O₇,
         the first layer is provided on a first side of the layer and contains cerium oxide doped with a lanthanum element, and
         the nickel oxide-containing layer is provided on a first side of the first layer opposite to a second side of the first layer that faces the layer and contains nickel oxide,
      and thereby generating, from the oxide represented by the composition formula, a solid electrolyte that has an apatite structure and is c-axis oriented; a step of placing a second layer that contains cerium oxide that is doped or not doped with an Ln element, where Ln represents a rare earth element other than cerium, on a second side of the layer, which contains the solid electrolyte, opposite to the first side of the layer that faces the first layer, and thereby obtaining a second stacked body; and
      a step of heating the second stacked body at 1000° C. or more,
   wherein the nickel oxide-containing layer has a thickness of 300 μm or more and 3000 μm or less.
[2]A production method for producing an anode-supported cell,
   the method comprising:
      a step of heating a first stacked body, in which a layer, a first layer, a nickel oxide-containing layer and an auxiliary support layer are stacked, at 1000° C. or more,
         wherein the layer contains an oxide represented by a composition formula: La₂Si₂O₇,
         the first layer is provided on a first side of the layer and contains cerium oxide doped with a lanthanum element,
         the nickel oxide-containing layer is provided on a first side of the first layer opposite to a second side of the first layer that faces the layer and contains nickel oxide, and
         the auxiliary support layer is provided on a first side of the nickel oxide-containing layer opposite to a second side of the nickel oxide-containing layer that faces the first layer,
      and thereby generating, from the oxide represented by the composition formula, a solid electrolyte that has an apatite structure and is c-axis oriented;
   a step of placing a second layer that contains cerium oxide that is doped or not doped with an Ln element, where Ln represents a rare earth element other than cerium, on a second side of the layer, which contains solid electrolyte, opposite to the first side of the layer that faces the first layer, and thereby obtaining a second stacked body; and
   a step of heating the second stacked body at 1000° C. or more.
[3] The production method as set forth in clause [1] or [2], wherein the Ln element comprises at least one selected from the group consisting of La, Nd, and Sm.
[4] The production method as set forth in any one of clauses [1] to [3], wherein the solid electrolyte comprising a composite oxide of lanthanum and silicon is generated.
[5] The production method as set forth in any one of clauses [1] to [4], wherein the solid electrolyte represented by a formula described below is generated:

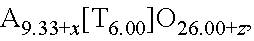

wherein A represents one or more elements selected from the group consisting of La, Ce, Nd, and Sm,
T represents Si,
x represents a number of −1.33 or more and 3.00 or less,
z represents a number of −5.00 or more and 5.20 or less, and
a ratio (A/T) of the number of moles of A relative to the number of moles of T is 1.33 or more and 3.61 or less.
[6] The production method as set forth in clause [1], further comprising:
   a step of, after heating the second stacked body to obtain a sintered second stacked body having a sintered second layer, placing a layer made of a material for an air electrode on a second side of the sintered second layer opposite to a first side of the sintered second layer that faces the layer, and thereby obtaining a third stacked body; and a step of heating the third stacked body.
[7] The production method as set forth in clause [2], further comprising:
   a step of, after heating the second stacked body to obtain a sintered second stacked body having a sintered second layer, placing a layer made of a material for an air electrode on a second side of the sintered second layer opposite to a first side of the sintered second layer that faces the layer, and thereby obtaining a third stacked body; and
   a step of heating the third stacked body.

### EXAMPLES

Hereinafter, the present invention will be described in further detail based on examples. However, the scope of the present invention is not limited to the examples given below. Unless otherwise stated, the percent sign “%” used herein means “mass %”.

### Example 1

### (1) Production and Heating of First Stacked Body

As a material composition used to produce a solid electrolyte, a La₂Si₂O₇ powder was weighed at 9.005 g, and ethanol was weighed at 4.933 g. These components of the material composition were mixed into a slurry. After that, the slurry was further mixed with 0.831 g of a PVB resin powder as a binder and 0.955 g of dibutyl phthalate as a plasticizer. In this way, a slurry used to produce a solid electrolyte was prepared.

As a material composition used to produce a first intermediate layer, a La_{0.5}Ce_{0.5}O_{1.75} powder was weighed at 10.104 g, and ethanol was weighed at 9.242 g. These components of the material composition were mixed into a slurry. After that, the slurry was further mixed with 1.136 g of a PVB resin powder as a binder and 1.164 g of dibutyl phthalate as a plasticizer. In this way, a slurry used to produce a first intermediate layer was prepared.

As a material composition used to produce a fuel electrode, a nickel oxide powder was weighed at 7.291 g, a La_{0.5}Ce_{0.5}O_{1.75} powder was weighed at 9.008 g, and ethanol was weighed at 15.75 g. These components of the material composition were mixed into a slurry. After that, the slurry was further mixed with 1.445 g of a PVB resin powder as a binder and 1.514 g of dibutyl phthalate as a plasticizer. In this way, a slurry used to produce a fuel electrode was prepared.

As a material composition used to produce a support layer, a NiO powder was weighed at 20.724 g, a La_{9.33}Si₆O₂₆ powder was weighed at 19.657 g, ethanol was weighed at 30.340 g, and spherical fine particles (with an average particle size of 30 m) of crosslinked polymethylmethacrylate as a pore forming agent was weighed at 10.115 g. These components of the material composition were mixed into a slurry. After that, the slurry was further mixed with 4.953 g of a PVB resin powder as a binder and 6.219 g of dibutyl phthalate as a plasticizer. In this way, a slurry used to produce a support layer was prepared.

Green sheets were produced from the slurries obtained above using an automatic film applicator. The thickness gap of the automatic film applicator was set to 40 m. The obtained oxide layer had a thickness of 20 m. The obtained first layer had a thickness of 19 m. The obtained nickel oxide layer had a thickness of 33 m. The obtained auxiliary support layer had a thickness of 220 m.

Next, the oxide layer, the first layer provided on one side of the oxide layer, the nickel oxide layer provided on a side of the first layer opposite to another side of the first layer facing the oxide layer, and the auxiliary support layer provided on a side of the nickel oxide layer opposite to another side of the nickel oxide layer facing the first layer were stacked and thermally press-bonded from one direction to obtain a first stacked body. The oxide layer, the first layer, and the nickel oxide layer stacked were each composed of one green sheet, and the auxiliary support layer stacked was composed of six green sheets. The thermal press-bonding was performed at a temperature of 60° C. and a pressure of 0.3 MPa.

The obtained first stacked body was heated at 1600° C. under the air atmosphere for 5 hours. Through this heating, a sintered first stacked body was obtained, and a solid electrolyte layer, a first intermediate layer, a fuel electrode, and a support layer were generated from the oxide layer, the first layer, the nickel oxide layer, and the auxiliary support layer, respectively.

### (2) Production and Heating of Second Stacked Body

As a material composition used to produce a second intermediate layer, a Sm_{0.2}Ce_{0.8}O_{1.9} powder was weighed at 4.5 g. The powder was mixed with 3.0 g of a solution obtained by dissolving 5 wt % ethyl cellulose in a-terpineol to prepare a slurry. In the sintered first stacked body, the slurry was applied in a thickness of 5 μm onto a side of the solid electrolyte layer opposite to another side of the solid electrolyte layer facing the sintered first layer to obtain a second stacked body. The obtained second stacked body was heated at 1400° C. under the air atmosphere for one hour. Through this heating, a second intermediate layer was generated.

### (3) Production and Heating of Third Stacked Body

As a material composition used to produce an air electrode, a La_{0.6}Sr_{0.4}Co_{0.2}Fe_{0.8}O_{3-δ} powder was weighed at 3.0 g. The powder was mixed with 4.5 g of a solution obtained by dissolving 5 wt % ethyl cellulose in a-terpineol to prepare a slurry. In the sintered second stacked body, the slurry was applied in a thickness of 10 μm onto a side of the sintered second layer opposite to another side of the sintered second layer facing the solid electrolyte layer to obtain a third stacked body. The obtained third stacked body was heated at 900° C. under the air atmosphere for one hour. Through this heating, an air electrode was generated.

In this way, an intended anode-supported cell was obtained.

### Example 2

In Example 1, the thickness gap of the automatic film applicator was changed to 60 μm to increase the thickness of the electrolyte. In addition thereto, a slurry prepared by changing the amount of the Sm_{0.2}Ce_{0.8}O_{1.9} powder used to produce the second intermediate layer to 1.5 g, and using 2.2 g of the α-terpineol solution of ethyl cellulose was used. Other than the above-described changes, an anode-supported cell was obtained in the same manner as in Example 1.

### Comparative Example 1

In Example 1, the La_{0.5}Ce_{0.5}O_{1.75} powder used to produce the first intermediate layer was replaced by a Sm_{0.2}Ce_{0.8}O_{1.9} powder in the same amount. In addition thereto, the heating temperature for heating the second stacked body was changed to 900° C. Other than the above-described changes, an anode-supported cell was obtained in the same manner as in Example 1.

### Comparative Example 2

In Example 1, the La_{0.5}Ce_{0.5}O_{1.75} powder used to produce the first intermediate layer was replaced by a Sm_{0.2}Ce_{0.8}O_{1.9} powder in the same amount. Other than the above-described change, an anode-supported cell was obtained in the same manner as in Example 1.

### Evaluation

For each of the anode-supported cells obtained in the examples and the comparative examples, the composition of the oxide contained in each layer was determined. Then, lanthanum contents n1 to n6 in each layer and the thickness of each layer were measured based on the following methods.

In addition thereto, in each of the examples and the comparative examples, after the sintered first stacked body was obtained, the solid electrolyte layer was subjected to XRD measurement. For each of the solid electrolyte layers of the anode-supported cells obtained in the examples, the presence of the apatite structure was checked. For each of the solid electrolyte layers of the anode-supported cells obtained in the examples and the comparative examples, c-axis orientation degree f was measured.

In addition thereto, for each of the anode-supported cells obtained in the examples and the comparative examples, peak power density was determined based on the following method. The results are shown in Table 1.

### Lanthanum Content

Using a cross section of an anode-supported cell taken substantially parallel to the thickness direction of the anode-supported cell, the Sr element content, the Co element content, the Fe element content, and the La element content in the air electrode were measured based on SEM (scanning electron microscope)-EDS point analysis. In Table 1, the Sr element content, the Co element content, the Fe element content, and the La element content are each shown as the proportion (mol %) of the measured element content relative to the total content of the Sr element, the Co element, the Fe element, and the La element.

Likewise, the Sm element content, the Ce element content, and the La element content in each of the second intermediate layer, the first intermediate layer, and the fuel electrode were measured in the same manner. The Sm element content, the Ce element content, and the La element content are each shown in Table 1 as the proportion (mol %) of the measured element content relative to the total content of the Sm element, the Ce element, and the La element.

Furthermore, the Si element content, the Sm element content, the Ce element content, and the La element content in each of the solid electrolyte layer and the support layer were measured. The Si element content, the Sm element content, the Ce element content, and the La element content are each shown in Table 1 as the proportion (mol %) of the measured element content relative to the total content of the Si element, the Sm element, the Ce element, and the La element.

### Thickness of Each Layer

The thickness of each layer was measured based on SEM-EDS.

### XRD Measurement

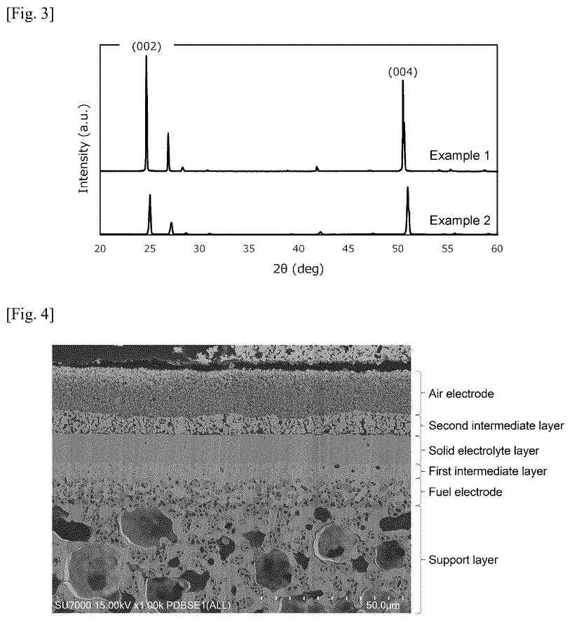

XRD measurement was performed under the following conditions using a fully automated multipurpose X-ray diffractometer SmartLab available from Rigaku Corporation as an XRD apparatus. XRD charts obtained in the examples are shown in FIG. 3.
X-ray tube voltage: 40 kV
X-ray tube current: 30 mA
X ray source: CuKα
Incident optical element: confocal mirror (CMF)
Light incident-side slit configuration: collimator size 1.4 mm×1.4 mm
Light receiving-side slit configuration: parallel slit analyzer 0.114 deg, and light receiving slit 20 mm
Detector: scintillation counter
Measurement range: 20=20 to 60 deg
Step width: 0.01 deg
Scan speed: 1 deg/min
   c-Axis Orientation Degree f

Data obtained from the XRD measurement described above was analyzed using PDXL 2 available from Rigaku Corporation. By selecting a straight line connecting endpoints as the background and a split pseudo-Voigt function as the peak shape, and then performing profile fitting, the peak intensities (integrated intensities) of the (002) plane and the (004) plane were obtained. The c-axis orientation degree f was calculated based on the formula (1) given above.

As described above, the peaks attributed to the (002) plane and the (004) plane are peaks that are specific to the c-axis orientation, and are independent peaks that do not overlap with diffraction angle values attributed to other planes. Even in the case where an overlap of peaks derived from different phases, which may be observed when the anode-supported cell has a multi-layer configuration, is observed, peak resolution can be performed in the same manner as ordinary XRD data analysis, and thus the peak intensities of only the (002) plane and the (004) plane can be obtained.

### Peak Power Density

At a temperature of 700° C., as a fuel gas, 100 ccm of hydrogen was introduced into the fuel electrode, and 80 ccm of nitrogen and 20 ccm of oxygen were introduced into the air electrode. The voltage was swept at 10 mV/min from OCV to OCV-0.9 V, and then, the voltage value and the current value were measured. The greatest value obtained by multiplying the measured voltage value by the current density value was defined as peak power density.

TABLE 1

| | | Example | Example | Comparative | Comparative |
|---|---|---|---|---|---|
| | | 1 | 2 | Example 1 | Example 2 |
| Air electrode | Sr content (mol %) | 16.19 | 14.10 | 22.05 | 17.17 |
| | Co content (mol %) | 10.78 | 11.15 | 8.73 | 10.39 |
| | Fe content (mol %) | 40.88 | 41.69 | 35.70 | 40.93 |
| | La content n3 | 32.20 | 33.10 | 33.53 | 31.52 |
| | (mol %) | | | | |
| | Thickness (μm) | 7.5 | 8.2 | 3.4 | 6.9 |
| Second intermediate | Sm content (mol %) | 19.46 | 11.63 | 19.93 | 13.35 |
| layer | Ce content (mol %) | 73.68 | 77.57 | 76.26 | 66.85 |
| | La content n4 | 6.86 | 10.79 | 3.82 | 19.81 |
| | (mol %) | | | | |
| | La/Ce | 0.093 | 0.14 | 0.050 | 0.30 |
| | Thickness (μm) | 8.1 | 2.3 | 3.9 | 0.5 |
| Solid electrolyte layer | Si content (mol %) | 34.00 | 36.52 | 34.94 | 38.54 |
| | Sm content (mol %) | 0.94 | 1.56 | 5.63 | 11.09 |
| | Ce content (mol %) | 2.20 | 2.67 | 5.54 | 5.04 |
| | La content n2 | 62.86 | 59.25 | 53.88 | 45.33 |
| | (mol %) | | | | |
| | Thickness (μm) | 10.3 | 14.0 | 10.4 | 8.2 |
| First intermediate layer | Sm content (mol %) | 1.00 | 1.28 | 7.42 | 8.55 |
| | Ce content (mol %) | 70.72 | 77.26 | 72.98 | 83.1 |
| | La content n5 | 28.29 | 21.46 | 19.60 | 8.33 |
| | (mol %) | | | | |
| | La/Ce | 0.40 | 0.28 | 0.27 | 0.10 |
| | Thickness (μm) | 5.6 | 5.2 | 3.0 | 6.0 |
| Fuel electrode | Sm content (mol %) | 1.27 | 1.40 | 7.75 | 8.23 |
| | Ce content (mol %) | 71.81 | 75.94 | 76.28 | 83.19 |
| | La content n1 | 26.92 | 22.66 | 15.96 | 8.58 |
| | (mol %) | | | | |
| | La/Ce | 0.37 | 0.30 | 0.21 | 0.10 |
| | Thickness (μm) | 7.4 | 2.3 | 6.9 | 5.2 |
| Support layer | Si content (mol %) | 36.45 | 37.06 | 43.60 | 37.99 |
| | Sm content (mol %) | 0.51 | 0.39 | 1.18 | 0.39 |
| | Ce content (mol %) | 1.46 | 1.17 | 2.35 | 1.34 |
| | La content n6 | 61.58 | 61.38 | 52.87 | 60.29 |
| | (mol %) | | | | |
| | Thickness (μm) | 1.8 | 1.9 | 1.5 | 1.6 |

| | | | | |
|---|---|---|---|---|
| n5/n2 | 0.45 | 0.36 | 0.36 | 0.18 |
| n4/n2 | 0.11 | 0.18 | 0.071 | 0.44 |
| n1/n2 | 0.43 | 0.38 | 0.30 | 0.19 |
| c-axis orientation degree | 0.7699 | 0.7842 | 0.7283 | 0.2991 |
| Peak power density at 700° C. (mW/cm²) | 830.8 | 668.9 | 202.0 | 73.9 |

As is clear from the results shown in FIG. 3, in the anode-supported cells obtained in the examples, peaks were detected at the (002) plane and the (004) plane that are specific to an apatite structure. Accordingly, it was confirmed that, in the anode-supported cells obtained in Examples 1 and 2, the solid electrolyte layer had an apatite structure.

Also, as is clear from the results shown in Table 1, it can be seen that the anode-supported cells obtained in the examples had a higher peak power density than that of the anode-supported cells obtained in the comparative examples.

### INDUSTRIAL APPLICABILITY

According to the present invention, it is possible to produce an anode-supported cell that has a high level of power generation characteristics.

1. A production method for producing an anode-supported cell, the method comprising:
heating a first stacked body, in which a layer, a first layer and a nickel oxide-containing layer are stacked, at 1000° C. or more,
wherein the layer contains an oxide represented by a composition formula: La₂Si₂O₇,
the first layer is provided on a first side of the layer and contains cerium oxide doped with a lanthanum element, and
the nickel oxide-containing layer is provided on a first side of the first layer opposite to a second side of the first layer that faces the layer and contains nickel oxide,
and thereby generating, from the oxide represented by the composition formula, a solid electrolyte that has an apatite structure and is c-axis oriented;
placing a second layer that contains cerium oxide that is doped or not doped with an Ln element, where Ln represents a rare earth element other than cerium, on a second side of the layer, which contains the solid electrolyte, opposite to the first side of the layer that faces the first layer, and thereby obtaining a second stacked body; and
heating the second stacked body at 1000° C. or more,
wherein the nickel oxide-containing layer has a thickness of 300 μm or more and 3000 μm or less.

2. A production method for producing an anode-supported cell, the method comprising:
heating a first stacked body, in which a layer, a first layer, a nickel oxide-containing layer and an auxiliary support layer are stacked, at 1000° C. or more,
wherein the layer contains an oxide represented by a composition formula: La₂Si₂O₇,
the first layer is provided on a first side of the layer and contains cerium oxide doped with a lanthanum element,
the nickel oxide-containing layer is provided on a first side of the first layer opposite to a second side of the first layer that faces the layer and contains nickel oxide, and
the auxiliary support layer is provided on a first side of the nickel oxide-containing layer opposite to a second side of the nickel oxide-containing layer that faces the first layer,
and thereby generating, from the oxide represented by the composition formula, a solid electrolyte that has an apatite structure and is c-axis oriented;
placing a second layer that contains cerium oxide that is doped or not doped with an Ln element, where Ln represents a rare earth element other than cerium, on a second side of the layer, which contains solid electrolyte, opposite to the first side of the layer that faces the first layer, and thereby obtaining a second stacked body; and
heating the second stacked body at 1000° C. or more.

3. The production method according to claim 1,
wherein the Ln element comprises at least one selected from the group consisting of La, Nd, and Sm.

4. The production method according to claim 1,
wherein the solid electrolyte comprising a composite oxide of lanthanum and silicon is generated.

5. The production method according to claim 1,
wherein the solid electrolyte represented by a formula described below is generated:
A_{9.33+x}[T_{6.00}]O_{26.00+z},
wherein A represents one or more elements selected from the group consisting of La, Ce, Nd, and Sm,
T represents Si,
x represents a number of −1.33 or more and 3.00 or less,
z represents a number of −5.00 or more and 5.20 or less, and
a ratio (A/T) of the number of moles of A relative to the number of moles of T is 1.33 or more and 3.61 or less.

6. The production method according to claim 1, further comprising:
after heating the second stacked body to obtain a sintered second stacked body having a sintered second layer, placing a layer made of a material for an air electrode on a second side of the sintered second layer opposite to a first side of the sintered second layer that faces the layer, and thereby obtaining a third stacked body; and
heating the third stacked body.

7. The production method according to claim 2, further comprising:
after heating the second stacked body to obtain a sintered second stacked body having a sintered second layer, placing a layer made of a material for an air electrode on a second side of the sintered second layer opposite to a first side of the sintered second layer that faces the layer, and thereby obtaining a third stacked body; and
heating the third stacked body.

8. The production method according to claim 2,
wherein the Ln element comprises at least one selected from the group consisting of La, Nd, and Sm.

9. The production method according to claim 2,
wherein the solid electrolyte comprising a composite oxide of lanthanum and silicon is generated.

10. The production method according to claim 2,
wherein the solid electrolyte represented by a formula described below is generated:
A_{9.33+x}[T_{6.00}]O_{26.00+z},
wherein A represents one or more elements selected from the group consisting of La, Ce, Nd, and Sm,
T represents Si,
x represents a number of −1.33 or more and 3.00 or less,
z represents a number of −5.00 or more and 5.20 or less, and
a ratio (A/T) of the number of moles of A relative to the number of moles of T is 1.33 or more and 3.61 or less.
